(19) United States
(12) Patent Application Publication
(10) Pub. No.: US 2017/0116772 A1
(43) Pub. Date: Apr. 27, 2017

(54) Particle Display

(71) Applicant: Cameron Mealad Shokri, Mckinney, TX (US)

(72) Inventor: Cameron Mealad Shokri, Mckinney, TX (US)

(21) Appl. No.: 15/168,247

(22) Filed: May 31, 2016

Related U.S. Application Data
(60) Provisional application No. 62/246,799, filed on Oct. 27, 2015.

(51) Int. Cl. G06T 15/04; G06T 15/50

(52) U.S. Cl. CPC G06T 15/04; G06T 15/50

(57) ABSTRACT

Traditional displays found in televisions and monitors are currently two dimensional in nature. Some of these displays have the ability to appear like a three dimensional display if the user wears glasses. This does not necessarily need to be the case if different technologies are used to create displays. There can be an alternative to traditional display technology by creating a three dimensional holograph particle display.

The display viewing area would consist of an enclosure of any shape composed of transparent material such as glass, acrylic, or plastic with varied amount of lightweight particle material enclosed in it. This material would be similar to physical properties of dust and would be abundant in the enclosure. The Lining of the bottom of the enclosure would be covered with mini speaker like devices that will create sonic waves that will suspend the particles in midair.

These speakers would then be connected to a video-to-sound converter card in a computer via electrical wires. The card would translate video with its textures into corresponding air wave output that would map the video frames via particles in the enclosure. The final output would create a loosely held together three dimensional image made of particles outlined in midair in the enclosure.

The top of the enclosure would be lined with an array of high powered multicolored LED or other light source also connected to the same computer. These light sources would project downwards onto the suspended particle mapped image. The light sources would provide both the color and texture for the suspended three dimensional images. The light source would receive its input from a video card designed to convert traditional two dimensional color-mapping into three dimensional projections of color/texture mapping to be transposed onto the particles by the light source array. The texture maps will also communicate with the video-to-sound converter card to move the particles into position to create the desired three dimensional texture surfaces.

Specially written software would allow for the converter cards to operate as specified above creating the desired three dimensional holographic images with texture. The particles will be stored in a resting place to the side of the display and can be released upon startup of the display via air tube pressure. It can also be returned to the rest place via sound wave or a vacuum if there is a system failure.

This display can be used as part of a new type of television, computer monitor, or anything else that requires a display.

1. I claim using a device as described above one can create an electronic display that produces color three dimensional holographic images with textures.

2. A display as in claim 1, further comprising of a computer with a card that would convert video into sonic waves via speaker like devices that would suspend particles in the correct position to produce a three dimensional frame.

3. A display as in claim 1, further comprising of a computer with a card that would convert two dimensional video into three dimensional light and texture mapping output for the suspended particles for the three dimensional image frames.

4. I claim that software can be written that would operate the converter cards that would correctly position the particles in midair via sonic waves with its corresponding colors and texture as it moves through image frames of the video.
